(19) United States
(12) Patent Application Publication
(10) Pub. No.: US 2003/0037944 A1
(43) Pub. Date: Feb. 27, 2003

(54) Flexible electrical coupling with conductive bonding jumper

(75) Inventor: Roger Pyron, Bartlett, TN (US)

Correspondence Address: HOFFMANN & BARON, LLP, 6900 JERICHO TURNPIKE, SYOSSET, NY, 11791, US

(73) Assignee: Thomas & Betts International, Inc., Sparks, NV

(21) Appl. No.: 10/215,336

(22) Filed: Aug. 8, 2002

Related U.S. Application Data
(60) Provisional application No. 60/311,161, filed on Aug. 8, 2001.

(51) Int. Cl. H02G 3/04

(52) U.S. Cl. 174/48

(57) ABSTRACT

A flexible electric coupling having a conductive bonding jumper for connecting two pieces of equipment in a harsh environment. The flexible electric coupling comprises a corrugated conduit having a raceway for electrical cables to pass therethrough. The flexible electric coupling provides flexibility, structural support, resistance to corrosion, as well as adequate current carrying capabilities provided by an interiorly located bonding jumper.

### FIELD OF THE INVENTION

The present invention relates to a flexible electrical coupling and, more specifically, to a flexible electrical coupling having a conductive bonding jumper for use in industrial, corrosive environments.

This application claims priority to U.S. Provisional Application No. 60/311,161, filed Aug. 8, 2001.

### BACKGROUND OF THE INVENTION

It is often required in industrial applications to make electrical connections between pieces of equipment and/or motors for running such equipment. Such industrial environments are typically quite harsh, often including conditions that are quite corrosive and which result in vibratory movement of the equipment and motors. Accordingly, to establish the required electrical connections, as well as to protect the connections from the harsh environments, flexible electrical conduits have been used.

Such known flexible conduits typically comprise an internal solid, corrugated stainless steel conduit that is terminated at each end, typically by a threaded steel fitting. A braid of external stainless steel is typically provided on the exterior of the corrugated conduit to provide additional strength, as well as protection against corrosive environments, since stainless steel has relatively high resistance to corrosion. Under the National Electrical Code (NEC), such flexible electrical conduit must meet the minimum standard of carrying electrical current so that if a motor or other piece of electrical equipment shorts, current can be transferred through the coupling to an appropriate ground. While stainless steel is advantageous because of its high corrosive resistance, its electrical conductivity property is relatively low. Accordingly, users frequently attach a bonding strap of higher conductivity material, such as bronze or brass, between the metal fittings attached to both ends of the coupling, so as to increase the electrical conductivity across the coupling and hence meet the NEC requirements for current-carrying capability. Disadvantageously, such additionally attached jumpers of bronze or brass add more cost to the coupling and do not provide the same benefit of high corrosive resistance as stainless steel. Furthermore, the additional strap tends to be relatively loose and often serves as an undesirable handle for users or workers to grasp during operation.

Accordingly, it is desirable to provide a flexible electrical coupling for use in industrial, corrosive environments that provides necessary electrical conductivity and resistance to corrosion, as well as being cost effective.

### SUMMARY OF THE INVENTION

The present invention is directed to a flexible electrical coupling member. The electrical coupling member is formed of a first tubular member comprising a flexible corrugated conduit having a raceway for passage of electrical cables, or wires, therethrough. First and second fittings terminate first and second ends respectively of the first tubular member. Each fitting has a housing with an interior in communication with the conduit raceway. A second tubular member is disposed circumferentially exterior of the first tubular member, and is used for structural support for providing strength to the first tubular member. A conductive member is secured circumferentially interior of the second tubular member, and is conductively attached to the first and second fittings.

In another embodiment, the present invention is a flexible electrical coupling member which has a first tubular member formed of a stainless steel corrugated conduit having a raceway for passage of electrical wires therethrough. First and second fittings terminate first and second ends respectively of the first tubular member. Each fitting has a housing with an interior in communication with the conduit raceway. A second tubular member is also in the electrical coupling member, the second tubular member being placed circumferentially exterior of the first tubular member and being formed of a braided stainless steel support member. A third tubular member is also included in the coupling member, the third tubular member being formed of a braided bonding jumper positioned between the first and second tubular members, and is conductively attached to the first and second fittings.

In a further embodiment, the present invention is a flexible electrical coupling member with a first tubular member comprising a flexible corrugated conduit having a raceway for passage of electrical wires therethrough. First and second fittings terminate first and second ends respectively of the first tubular member. Each of the fittings is formed of a housing with an interior in communication with the conduit raceway. A second tubular member circumferentially exterior of the first tubular member is formed from a braided mesh of at least two materials. One of the at least two materials possesses a higher electrical conductivity than the other material. The other material possesses a higher strength than the first material.

### BRIEF DESCRIPTION OF THE DRAWINGS

FIG. 1 is a schematic representation of an electrical connection between two pieces of equipment protected by the flexible electrical coupling of the present invention.

FIG. 2 is a partially cross-sectioned longitudinal view of the flexible electrical coupling of FIG. 1, fragmented for clarity and to show details thereof.

FIG. 3 is a partially cross-sectioned longitudinal view of the flexible electrical coupling of FIGS. 1 and 2, fragmented for clarity and with a section cut away to show further details thereof.

FIG. 4 is a side elevational view of the bonding jumper of the present invention.

### DETAILED DESCRIPTION OF THE PREFERRED EMBODIMENTS

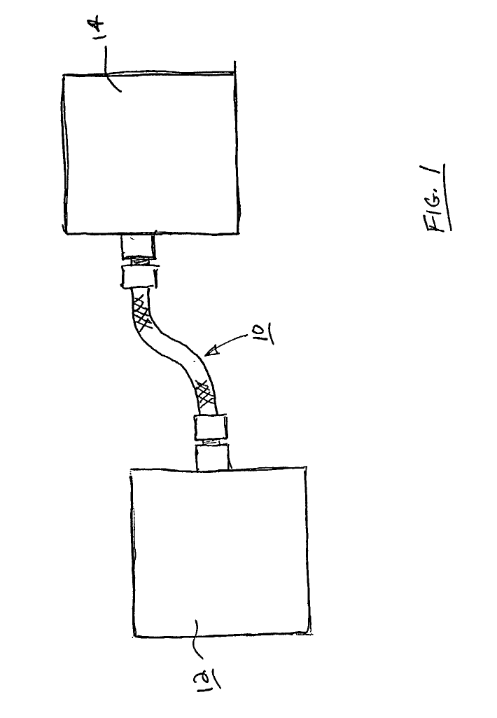

Turning now to the drawing figures, there is shown in FIG. 1a flexible electrical coupling 10 interconnecting two pieces of electrical equipment 12 and 14. The electrical equipment 12 and 14 may be electrical motors, machinery or the like which are electrically powered and which are required to be electrically interconnected for operation. Such pieces of equipment 12 and 14 interconnected by flexible electrical coupling 10 are commonly used in industrial and construction applications where the environmental conditions are typically harsh with the equipment being subjected to corrosive elements and vibratory movements. Electrical current carrying cables (not shown) electrically interconnect equipment 12 and 14 through the flexible electrical coupling 10, with coupling 10 thereby protecting such electrical cables and the interconnections between the equipment 12 and 14. Because pieces of equipment 12 and 14 may move relative to each other, coupling 10 is required to have sufficient flexibility to accommodate such movement. In addition, it is required by the National Electrical Code that the coupling 10 have the capability for carrying a minimum current so that if there is a short in either piece of equipment 12 or 14, current can be suitably transferred through the coupling 10 to ground, thereby reducing the risk of personal injury or electrocution.

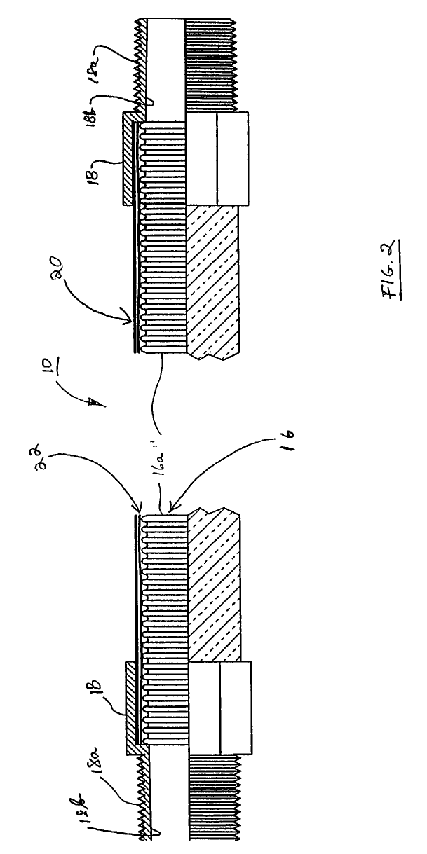

Referring now to FIG. 2, the details of the coupling 10 are described. Coupling 10 comprises an internal corrugated conduit 16 terminated on each end by a metallic electrical fitting 18. Corrugated conduit 16 is preferably formed of stainless steel and is of generally solid tubular construction having an internal raceway 16a running throughout its length for receipt therethrough of electrical cables. Conduit 16 being corrugated is generally relatively flexible and is preferably formed of stainless steel because of its generally high resistance to corrosion.

Each fitting 18 terminating the conduit 16 at each end is formed of metal, preferably stainless steel, and is suitably attached to the conduit 16 by welding, brazing or other appropriate securement techniques. In the embodiment shown, fitting 18 includes an exterior threaded portion 18a by which the terminated conduit 16 may be attached to each piece of electrical equipment 12 and 14, respectively. Each fitting 18 further comprises an interior opening 18b that communicates with the conduit raceway 16a for receipt therethrough of electrical cables. It should be appreciated that fitting 18 may also be provided with an internal threaded portion for attachment thereof to pieces of equipment 12 and 14.

Coupling 10 also comprises an external, flexible strength member 20 that is preferably resistive to corrosion. In the preferred form, strength member 20 is a stainless steel wire braid that is supported externally of the conduit 16 and is suitably secured thereto with its longitudinal ends respectively extending beneath the fittings 18. Braiding 20 provides additional strength to the coupling 10 and, due to braiding, is sufficiently flexible to accommodate required vibratory and other operational movements.

In accordance with the invention, a bonding jumper 22, formed of relatively high electrical conductivity material, is supported by the conduit 16 and electrically connected to each fitting 18. Accordingly, a relatively good electrical path is established over the length of the coupling 10 between each fitting 18 by the jumper 22.

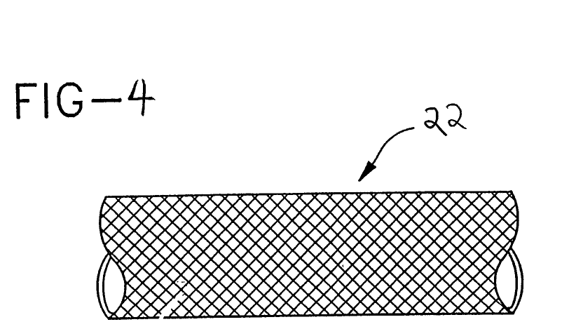

Jumper 22 in one arrangement is disposed externally of the conduit 16 and internally of the external braiding 20. Jumper 22 may be a braided tubular structure as shown in FIG. 4, or a solid strap or ribbon, formed of bronze, brass or copper, with tin plating, and preferably braided for flexibility and strength. Jumper 22 may be attached to each fitting by a pressure fit or crimped to a standard electrical lug and welded to each fitting 18. In disposition internally of the external braiding 20, jumper 22 is not directly exposed to corrosive environments and, as such, need not necessarily be formed of material having high resistance to corrosion. In addition, disposition of the jumper 22 internally of the braiding 20 provides for a neater coupling 10 without loose parts that may be used by workers to grab during operation.

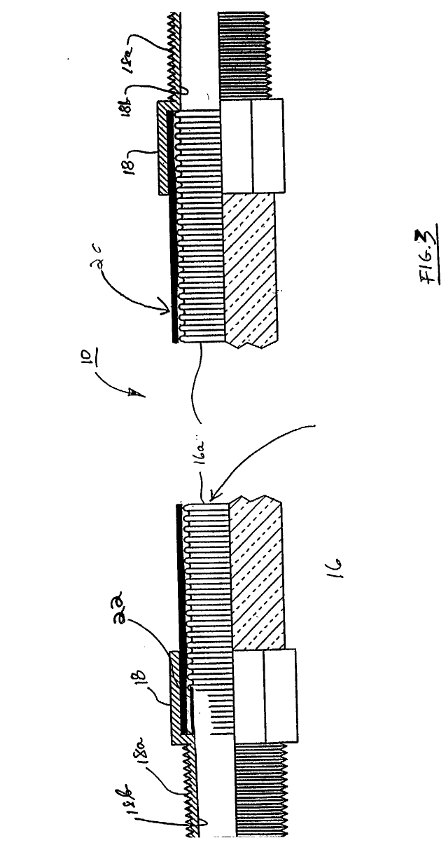

In an alternative arrangement shown in FIG. 3, bonding jumper 22 may be disposed internally within the conduit 16 within the raceway 16a and suitably secured internally of each fitting 18.

In a further arrangement, a bonding jumper may be integrally woven (not shown) into the external braiding 20, whereby the braiding may comprise both stainless steel and higher conductivity wires, such as bronze, brass or copper, which may also be tin plated.

Having described the preferred embodiments herein, it should be appreciated that the flexible electrical coupling described herein provides various improvements over the known flexible couplings. It should be appreciated, however, that the preferred embodiments are intended to be illustrative rather than limiting and that variations may be made thereto without departing from the contemplated scope of the invention.

What is claimed is:

1. A flexible electrical coupling member comprising:
a first tubular member comprising a flexible corrugated conduit having a raceway for passage of electrical cables therethrough;
first and second fittings terminating first and second ends respectively of said first tubular member, said fittings each comprising a housing with an interior in communication with said conduit raceway;
a second tubular member disposed exteriorly of said first tubular member comprising a structural support member for providing strength to said first tubular member; and
a conductive member disposed interiorly of said second tubular member, said conductive member conductively attached to said first and second fittings.

2. A coupling member according to claim 1 wherein said conductive member is a braided tubular member.

3. A coupling member according to claim 1 wherein said conductive member is disposed exteriorly of said first tubular member.

4. A coupling member according to claim 1 wherein said conductive member is disposed interiorly of said first tubular member.

5. A coupling member according to claim 1 wherein said conductive member is formed from a conductive material selected from the group consisting of bronze, brass, and copper.

6. A coupling member according to claim 5 wherein said conductive member further comprises tin plating.

7. A coupling member according to claim 1 wherein said first tubular member is comprised of stainless steel.

8. A coupling member according to claim 1 wherein said second tubular member is a braided tubular member.

9. A coupling member according to claim 8 wherein said braided tubular member is formed of stainless steel.

10. A coupling member according to claim 1 wherein said fittings are adapted to connect two pieces of electrical equipment.

11. A flexible electrical coupling member comprising:
a first tubular member comprising a stainless steel corrugated conduit having a raceway for passage of electrical wires therethrough;
first and second fittings terminating first and second ends respectively of said first tubular member, said fittings each comprising a housing with an interior in communication with said conduit raceway;
a second tubular member circumferentially exterior of said first tubular member comprising a braided stainless steel support member; and
a third tubular member comprising a braided bonding jumper positioned between said first and second tubular members and conductively attached to said first and second fittings.

12. A coupling member according to claim 11 wherein said third tubular member is formed from a material selected from the group consisting of bronze, brass, and copper.

13. A flexible electrical coupling member comprising:
a first tubular member comprising a flexible corrugated conduit having a raceway for passage of electrical wires therethrough;
first and second fittings terminating first and second ends respectively of said first tubular member, said fittings each comprising a housing with an interior in communication with said conduit raceway; and
a second tubular member circumferentially exterior of said first tubular member and comprising a braided mesh of at least two materials, one material having a higher electrical conductivity than another material.

14. A coupling member according to claim 13 wherein said other material of said braided mesh has a higher strength than said one material.

15. A coupling member according to claim 14 wherein said one material is selected from the group consisting of bronze, brass, and copper.

16. A coupling member according to claim 15 wherein said other material is stainless steel.
